(19) United States
(12) Patent Application Publication
(10) Pub. No.: US 2013/0320058 A1
(43) Pub. Date: Dec. 5, 2013

(54) HITCH-BALL TYPE CARRY DEVICE

(71) Applicant: Chiu-Kuei WANG, Taichung City (TW)

(72) Inventor: Chiu-Kuei WANG, Taichung City (TW)

(21) Appl. No.: 13/901,473

(22) Filed: May 23, 2013

(30) Foreign Application Priority Data
May 31, 2012 (TW) 101119441

(51) Int. Cl. B60R 9/06

(52) U.S. Cl. CPC B60R 9/06
USPC 224/520

(57) ABSTRACT

A hitch-ball type carry device includes a base, a clamp unit and a support unit. The base has a reception member which has two side plates. The clamp unit has a guiding member and two through holes. The support unit has a bar, a positioning part and a support frame, wherein the positioning part and the clamp unit are connected to the base. The clamp unit and the reception member are separated from or mounted to the bitch ball by pivoting the support frame to operate a link unit connected to the base.

### FIELD OF THE INVENTION

The present invention relates to a hitch-ball type carry device, and more particularly, to a hitch-ball type carry device for connecting with the hitch ball at rear end of a vehicle.

### BACKGROUND OF THE INVENTION

The hitch ball is connected to the rear end of a vehicle, and the conventional bicycle carry device has a clamp unit which is equal or slightly larger than the hitch ball. The clamp unit has a positioning slot on the bottom thereof and a positioning bar is located on the top of the clamp unit. The clamp unit clamps the hitch ball which is restricted by the clamp unit on the periphery and the top thereof. The positioning slot is engaged with the lower edge of the hitch ball, and the positioning bar presses the hitch ball in the clamp unit.

However, when bicycles are positioned on the bicycle carry device, the user has to simultaneously hold the support frame and operate the positioning bar to position the hitch ball in the clamp unit, so that the operation is not convenient for the users.

The hitch ball reacts a reaction force to the positioning bar when bicycles are positioned on the bicycle carry device, so that the positioning bar can be deformed, or loosened or even damaged, and the hitch ball is separated from the clamp unit to cause dangerous situation on roads.

The present invention intends to provide a hitch-ball type carry device to improve the shortcomings of the conventional carry device.

### SUMMARY OF THE INVENTION

The present invention relates to a hitch-ball type carry device and comprises a base having a reception member which has two side plates. Each of the two side plates has a fixing hole, an adjustment hole and a curved slot defined therein. At least two link units each have a fixing plate, a first link and a second link. Each of the fixing plates has two first holes defined in two ends thereof, each of the first links has two second holes defined in two ends thereof, and each of the second links has two third holes defined in two ends thereof. A pin extends through the overlapped first, second and third holes. The at least two link units are connected to two sides of the side plates of the base. Another pin extends through the first hole in one of two ends of each of the fixing plates and the adjustment hole of each of the side plates. Yet another pin extends through the overlapped first, second and third holes and the curved slot of each of the side plates. A clamp unit has a guiding member, two pivotal holes and two through holes. A pin extends through the pivotal holes and the third holes of two respective free ends of the second links. A support unit has a bar, a positioning part and a support frame. The bar has a fixing hole. The positioning part has two pivotal holes on two sides thereof and the two pivotal holes are located corresponding to the through hole of the clamp unit and the fixing holes of the base. A pin extends through the fixing holes, the through holes and the pivotal holes. A pin extends through the fixing hole of the bar and the second holes of two respective free ends of the first links.

The primary object of the present invention is to provide a hitch-ball type carry device which is stable and easily operated. The adjustment unit allows the user to adjust the distance between the reception member and the clamp unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hitch-ball type carry device of the present invention;

FIG. 2 is another perspective view to show the hitch-ball type carry device of the present invention;

FIG. 3 is an exploded view to show the hitch-ball type carry device of the present invention;

FIG. 4 shows the first clamping action of the hitch-ball type carry device of the present invention;

FIG. 5 shows the second clamping action of the hitch-ball type carry device of the present invention;

FIG. 6 shows the third clamping action of the hitch-ball type carry device of the present invention;

FIG. 7 shows the fourth clamping action of the hitch-ball type carry device of the present invention;

FIG. 8 shows the fifth clamping action of the hitch-ball type carry device of the present invention;

FIG. 9 is a side cross sectional view of the hitch-ball type carry device of the present invention;

FIG. 10 shows the operation of the adjustment unit of the hitch-ball type carry device of the present invention;

FIG. 11 shows that the hitch-ball type carry device of the present invention is connected to the rear end of a vehicle;

FIG. 12 shows that the support frame of the hitch-ball type carry device of the present invention is replaced with a netted basket, and

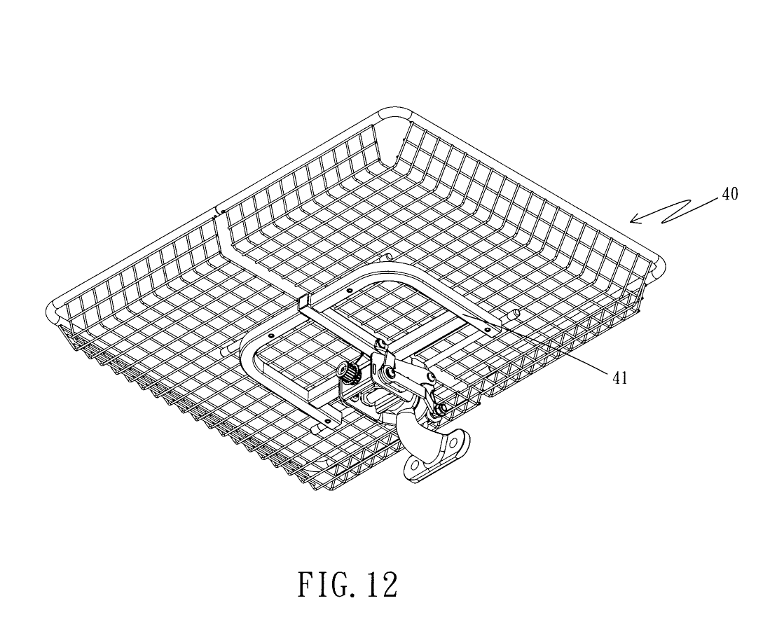

FIG. 13 shows that the support frame of the hitch-ball type carry device of the present invention is replaced with a bicycle carry rack.

### DETAILED DESCRIPTION OF THE PREFERRED EMBODIMENT

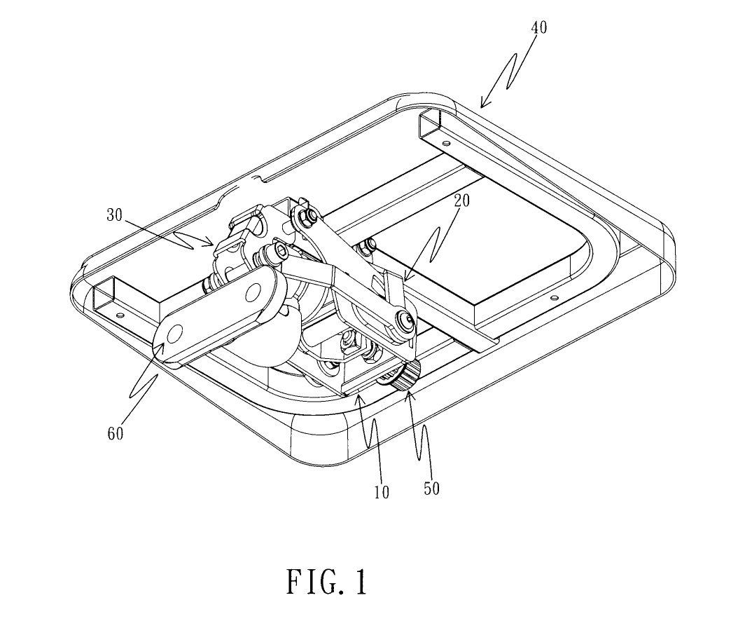

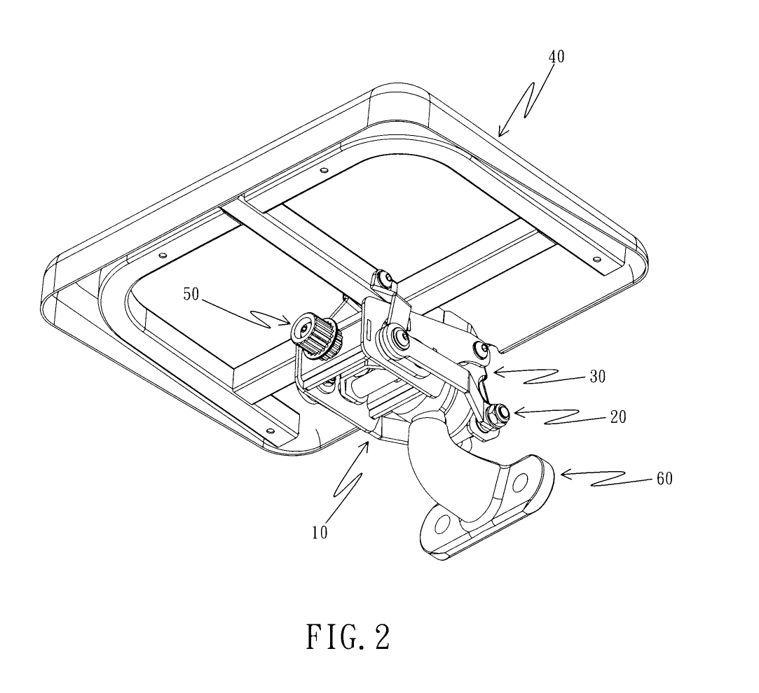

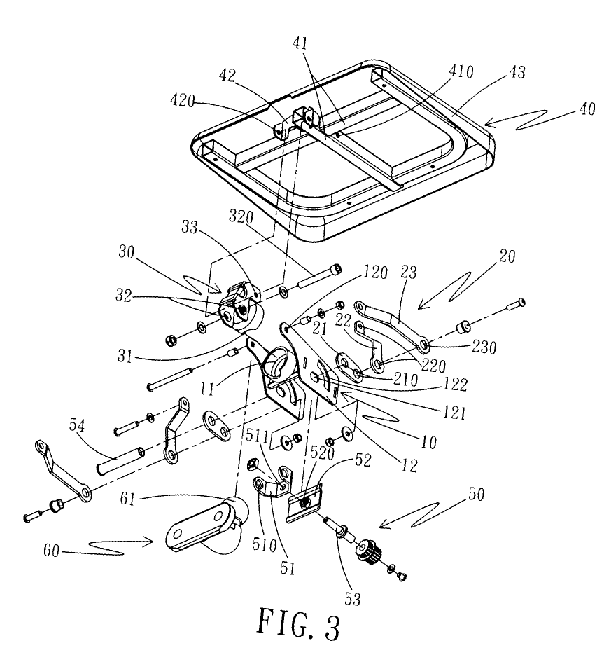

Referring to FIGS. 1 to 3, the hitch-ball type carry device of the present invention comprises a base 10 which has a reception member 11 having two side plates 12. Each of the two side plates 12 has a fixing hole 120, an adjustment hole 121 and a curved slot 122 defined therein.

At least two link units 20 each have a fixing plate 21, a first link 22 and a second link 23. Each of the fixing plates 21 has two first holes 210 defined in two ends thereof, each of the first links 22 has two second holes 220 defined in two ends thereof, and each of the second links 23 has two third holes 230 defined in two ends thereof. A pin extends through the overlapped first, second and third holes 210, 220, 230. The at least two link units 20 are connected to two sides of the side plates 12 of the base 10. Another pin extends through the first hole 210 in one of two ends of each of the fixing plates 21 and the adjustment hole 121 of each of the side plates 12. Yet another pin extends through the overlapped first, second and third holes 210, 220, 230 and the curved slot 122 of each of the side plates 12.

A clamp unit 30 has a guiding member 31, two pivotal holes 32 and two through holes 33. A pin 320 extends through the pivotal holes 32 and the third holes 230 of two respective free ends of the second links 23.

A support unit 40 has a bar 41, a positioning part 42 and a support frame 43, wherein the bar 41 has a fixing hole 410. The positioning part 42 has two pivotal holes 420 on two sides thereof and the two pivotal holes 420 are located corresponding to the through hole 33 of the clamp unit 30 and the fixing holes 120 of the base 10. A pin extends through the fixing holes 120, the through holes 33 and the pivotal holes 420. A pin extends through the fixing hole 410 of the bar 41 and the second holes 220 of two respective free ends of the first links 22.

An adjustment unit 50 is connected between the two side plates 12 and has a U-shaped frame 51, a board 52, an adjustment bolt 53 and a tube 54. Two guide holes 510 are defined in two ends of the U-shaped frame 51 and the board 52 has a threaded hole 520. A central hole 511 is defined through the U-shaped frame 51. The adjustment bolt 53 is threadedly connected to the threaded hole 520 and extends through the central hole 511. The tube 54 extends through the first holes 210 of the fixing plates 21 and is connected to the adjustment holes 121 of the two side plates 12.

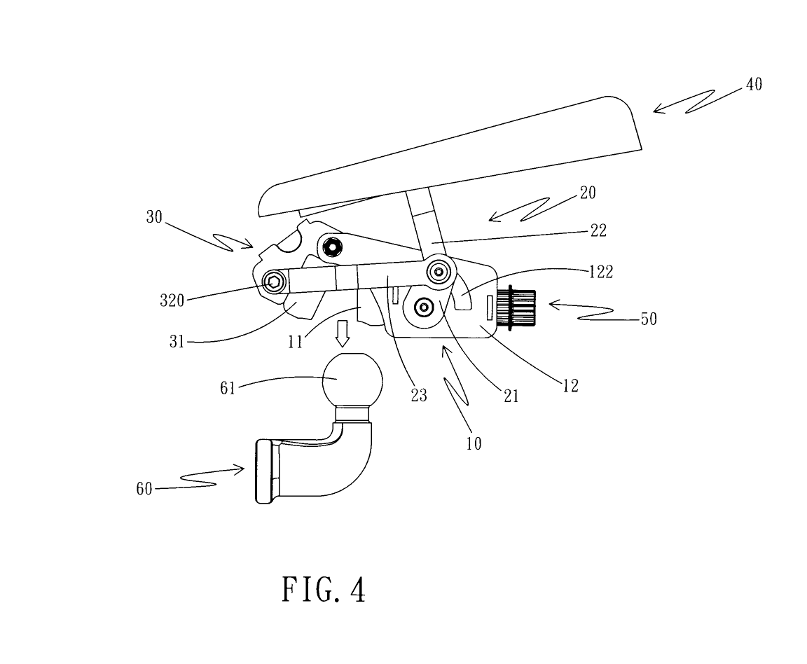

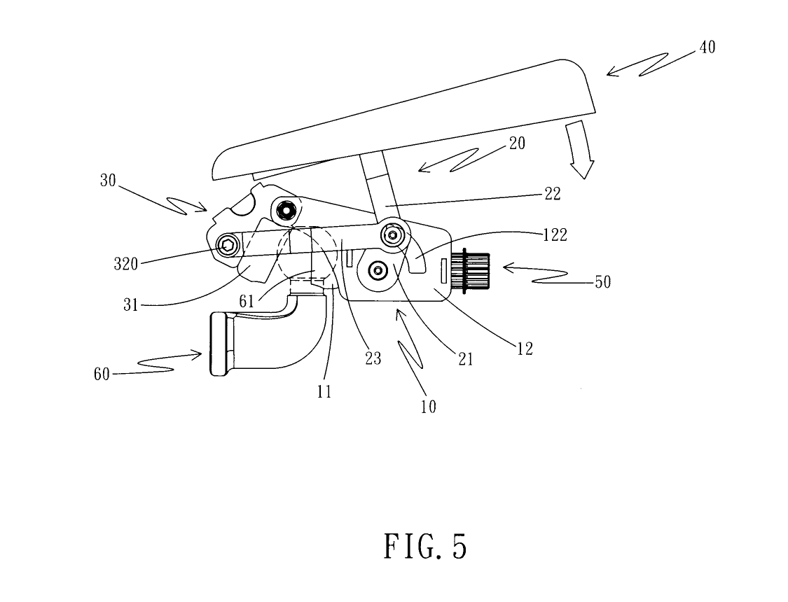

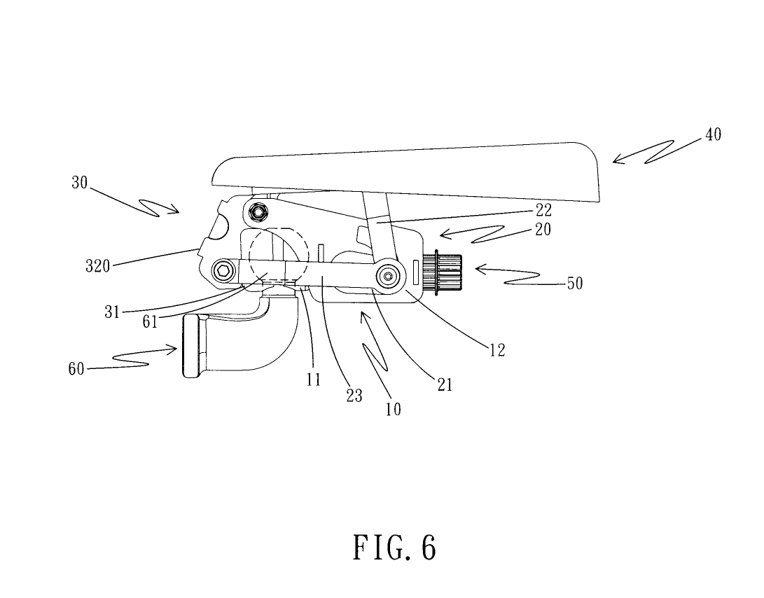

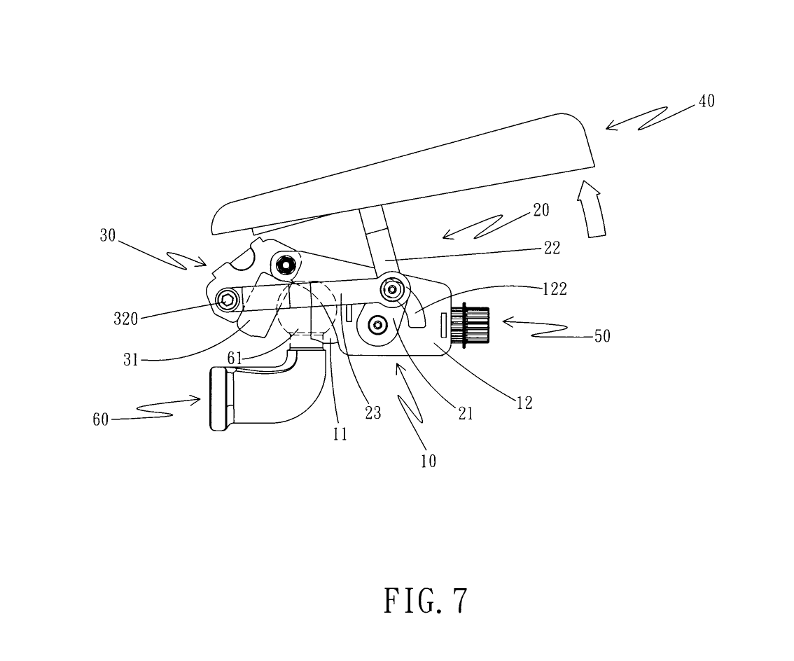

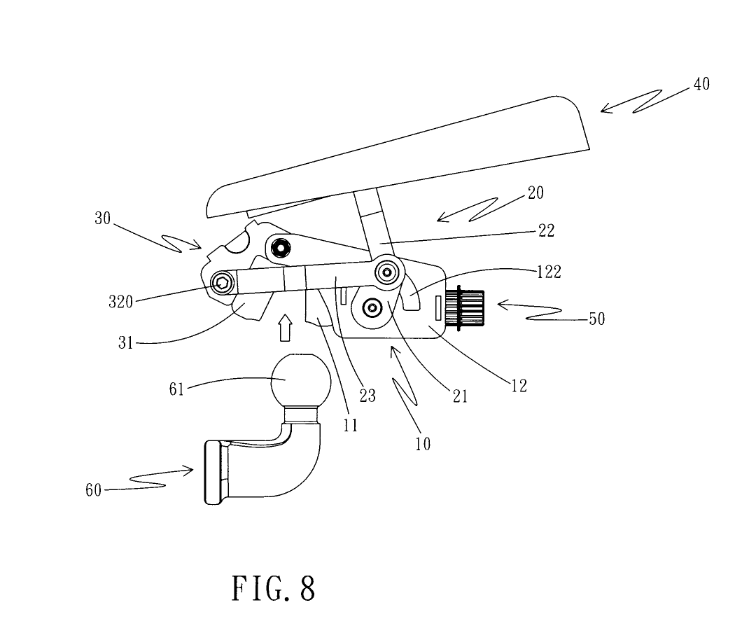

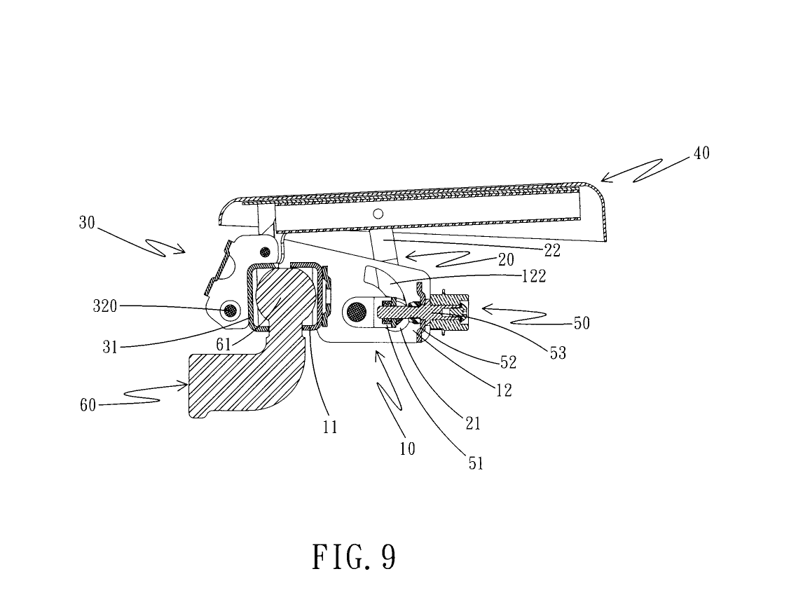

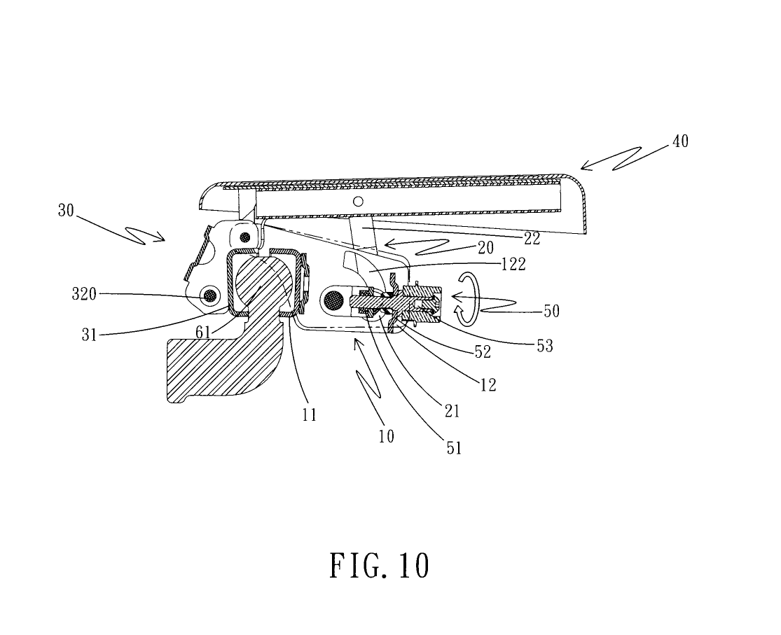

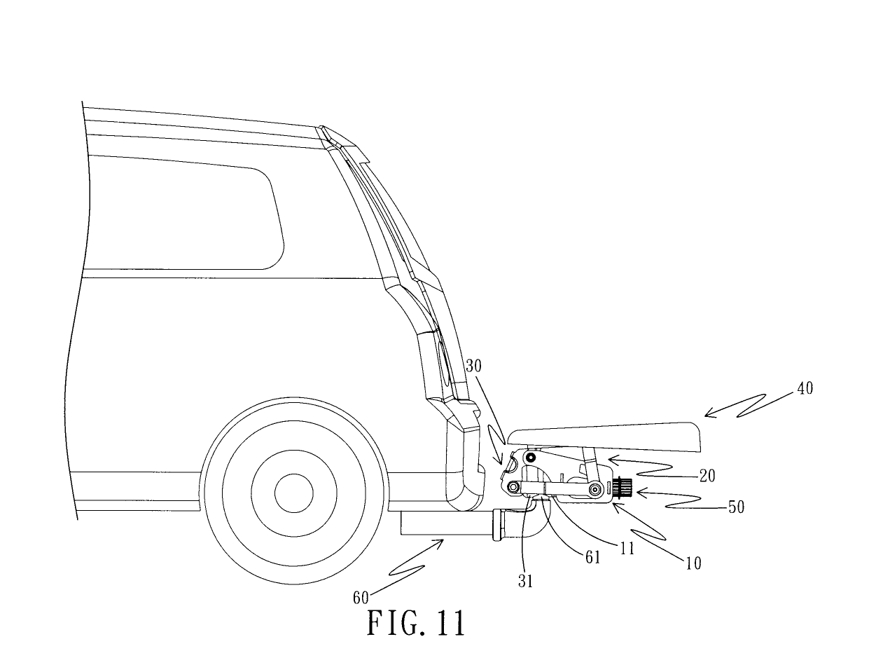

As shown in FIGS. 4 to 11, which show the five clamping actions of the present invention, and the support frame 43 is a pedal in this embodiment. The two link units 20 are respectively connected to outsides of the two side plates 12 of the base 10.

The pin extends through the first hole 210 in one of two ends of each of the fixing plates 21 and the adjustment hole 121 of each of the side plates 12. Yet another pin extends through the overlapped first, second and third holes 210, 220, 230 and the curved slot 122 of each of the side plates 12. The pin 320 extends through the pivotal holes 32 and the third holes 230 of two respective free ends of the second links 23. The two pivotal holes 420 of the positioning part 42 are located corresponding to the through hole 33 of the clamp unit 30 and the fixing holes 120 of the base 10. The pin extends through the second hole 220 of one end of each of the first link 22s and the fixing hole 410 of the bar 41. The adjustment unit 50 is connected between the two side plates 12 and has a U-shaped frame 51 which has the guide holes 510 which are located corresponding to the adjustment holes 121 of the side plates 12. The tube 54 pivotably connects the fixing plates 21, the first links 22 and the second links 23. The reception member 11 of the base 10 is opened and is mounted to the hitch ball 61. When the support frame 43 is pivoted downward, the first links 22 of the link units 20 connected with the bar 41 move the fixing plates 21 and the second links 23 to be moved along the curved slots 122 of the side plates 12 of the base 10. The clamp unit 30 is pushed by the second links 23 and pivoted toward the reception member 11 to clamp the hitch ball 61 of the hitch unit 60. When support frame 43 is pivoted upward, the clamp unit 30 is pivoted away from the reception member 11 to release the hitch ball 61. It is convenient for the users to pivot the support frame 43 to clamp or release the hitch ball 61.

The U-shaped frame 51 is moved by operating the adjustment bolt 53, the tube 54 drives the fixing plates 21 to move in the adjustment holes 121 of the side plates 12, so that the distance between the guide member 31 of the clamp unit 30 and the reception member 11 of the base 10 is adjustable. By this way, the present invention can be used to different sizes of the hitch ball 61.

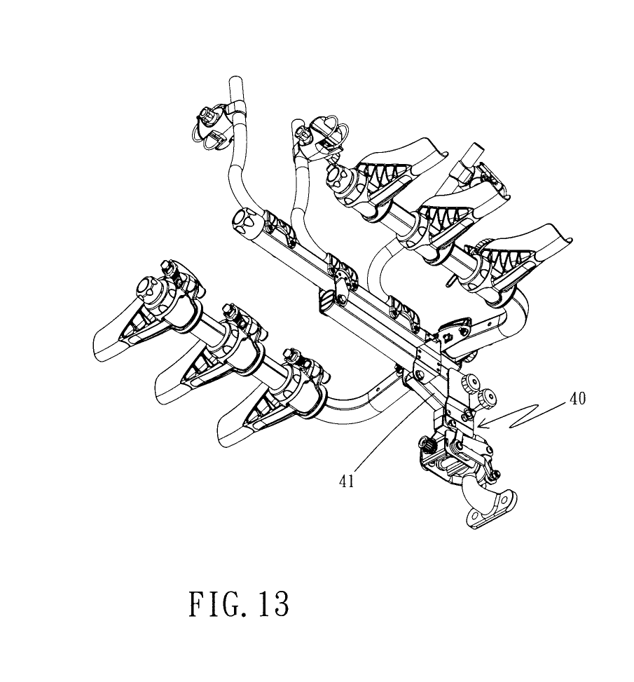

Referring to FIGS. 13 to 14, the support frame 43 of the support unit 40 can be a netted basket or a bicycle carry rack.

It is convenient for the users to pivot the support frame 43 downward to move the fixing plates 21 and the second links 23 along the curved slots 122 of the side plates 12 of the base 10 so that the clamp unit 30 is pushed by the second links 23 and pivoted toward the reception member 11 to clamp the hitch ball 61 of the hitch unit 60.

The distance between the guide member 31 of the clamp unit 30 and the reception member 11 of the base 10 can be adjustable to allow the present invention to be used to different sizes of the hitch ball 61.

While we have shown and described the embodiment in accordance with the present invention, it should be clear to those skilled in the art that further embodiments may be made without departing from the scope of the present invention.

What is claimed is:

1. A hitch-ball type carry device comprising:
a base having a reception member which has two side plates, a fixing hole defined in each of the two side plates;
a clamp unit having a guiding member and two through holes;
a support unit having a bar, a positioning part and a support frame, the positioning part and the clamp unit connected to the base, and
the clamp unit and the reception member adapted to be separated from or mounted to a bitch ball by pivoting the support frame to operate a link unit connected to the base.

2. The device as claimed in claim 1, wherein the support frame of the support unit is a pedal.

3. The device as claimed in claim 1, wherein the support frame of the support unit is a netted basket.

4. The device as claimed in claim 1, wherein the support frame of the support unit is a bicycle carry rack.

5. A hitch-ball type carry device comprising:
a base having a reception member which has two side plates, a fixing hole defined in each of the two side plates;
a clamp unit having a guiding member and two through holes;
a support unit having a bar, a positioning part and a support frame, the positioning part having two pivotal holes on two sides thereof and the two pivotal holes located corresponding to the through hole of the clamp unit and the fixing holes of the base, a pin extending through the fixing holes, the through holes and the pivotal holes, and
the clamp unit and the reception member adapted to be separated from or mounted to a bitch ball by pivoting the support frame to operate a link unit connected to the base.

6. The device as claimed in claim 5, wherein the support frame of the support unit is a pedal.

7. The device as claimed in claim 5, wherein the support frame of the support unit is a netted basket.

8. The device as claimed in claim 5, wherein the support frame of the support unit is a bicycle carry rack.

9. A hitch-ball type carry device comprising:
a base having a reception member which has two side plates, each of the two side plates having a fixing hole, an adjustment hole and a curved slot defined therein;
at least two link units and each link unit having a fixing plate, a first link and a second link, each of the fixing plates having two first holes defined in two ends thereof, each of the first links having two second holes defined in two ends thereof, each of the second links having two third holes defined in two ends thereof, a pin extending through the overlapped first, second and third holes, the at least two link units connected to two sides of the side plates of the base, another pin extending through the first hole in one of two ends of each of the fixing plates and the adjustment hole of each of the side plates, yet another pin extending through the overlapped first, second and third holes and the curved slot of each of the side plates;
a clamp unit having a guiding member, two pivotal holes and two through holes, a pin extending through the pivotal holes and the third holes of two respective free ends of the second links, and
a support unit having a bar, a positioning part and a support frame, the bar having a fixing hole, the positioning part having two pivotal holes on two sides thereof and the two pivotal holes located corresponding to the through hole of the clamp unit and the fixing holes of the base, a pin extending through the fixing holes, the through holes and the pivotal holes, a pin extending through the fixing hole of the bar and the second holes of two respective free ends of the first links.

10. The device as claimed in claim 5, wherein an adjustment unit is connected between the two side plates and has a U-shaped frame, a board and an adjustment bolt, two guide holes are defined in two ends of the U-shaped frame and the board has a threaded hole, a central hole is defined through the U-shaped frame, the adjustment bolt is threadedly connected to the threaded hole and extends through the central hole, the pin extending through the first, second and third holes of the fixing plate, the first link and the second link extends through the guide holes of the U-shaped frame and the adjustment holes of the side plates.

11. The device as claimed in claim 10, wherein the support frame of the support unit is a pedal.

12. The device as claimed in claim 10, wherein the support frame of the support unit is a netted basket.

13. The device as claimed in claim 10, wherein the support frame of the support unit is a bicycle carry rack.
